(19) United States
(12) Patent Application Publication
(10) Pub. No.: US 2012/0239591 A1
(43) Pub. Date: Sep. 20, 2012

(54) METHOD OF CALCULATING THE MARKET VALUE OF INDIVIDUAL PATENTS WITHIN A PATENT LANDSCAPE

(76) Inventors: G. Edward Powell, JR., Nashville, TN (US); N. Edward White, Austin, TX (US); Mark T. Lane, Franklin, TN (US)

(21) Appl. No.: 13/048,682

(22) Filed: Mar. 15, 2011

(51) Int. Cl. G06Q 40/06

(52) U.S. Cl. 705/36 R

(57) ABSTRACT

A method for deriving patent market value estimates within a patent landscape utilizing a relative metric score for all patents in the landscape, calibrating said market values by using a percentage of the known market values of patent portfolio owners, for example publicly traded companies with known patent portfolios. This method is based on the premise that the patents owned by said entities contribute to the market values of these entities, and describes a complete end-to-end process for estimating the market values for all patents within a patent landscape. This method also includes a set of steps useful for estimating the amount of revenue some patents may generate.

### BACKGROUND OF THE INVENTION

1. Field of the Invention

The present invention relates to the field of asset valuation and, in particular, to methods of computer-based market valuation of patents within a patent landscape using a relative metric score and portfolios of patents from companies or groups with known market valuations for calibration.

2. Description of the Related Art

Intellectual property represents an increasingly significant portion of the wealth and assets of the global community. Patents are an important component of intellectual property, and thus the ability to determine values and value ranges for patents has increasing utility.

There are at least four common methods of patent valuation. A cost-based approach looks to the cost of developing the patent, often adjusting that cost to present value, but is often inaccurate due to its reliance upon only a single factor. A market-based approach looks to recent transactions involving similar patents, but while arguably quite accurate requires the identification of similar patents as well as access to information about the details of what are often private transactions. An income-based approach looks to potential income streams, calculating discounted cash flow to derive a present value. An option-based approach further refines the income-based approach by examining the patent at various stages in its development, contrasting development costs with potential revenue streams, in order to provide owners with an early indication of value, which can then be used to better steer the underlying technology development.

The present invention comprises novel extensions to both the market-based and income-based approaches. By looking to companies with a known market value, and designating a percentage of that market value to each company's patent portfolio, it is possible to circumvent the need for access to the details of private transaction information. Then, by utilizing known classification systems such as that used by the USPTO, similar patents can be identified and assigned a market value, even when said patents are owned by private entities. Further, by combining potential income streams with network theory, it is possible to generate valuation numbers for patents that cannot otherwise be assigned a revenue stream, and thereby use that revenue stream to generate a second valuation, which can then serve as both a check and an adjunct to the initial valuation.

### BRIEF SUMMARY OF THE INVENTION

There are numerous methodologies for estimating the value or worth of any particular patent. Many of these are time consuming and require interaction with the owner of a patent, as well as the gathering of information, including royalties already being collected, expected time period that revenue production is to continue, knowledge of specific infringement or use by other intellectual property, and products directly or indirectly tied to the claims of a patent. Some methodologies include treating patents as options on intellectual property, or considering patents as part of a particular offensive or defensive strategy. There is a need, however, to have a computer-based methodology that can be used to estimate the value or worth of any patent within a patent landscape, so that such valuations can be quickly calculated, sorted, grouped, and presented to aid experts charged with the discovery and study of the worth of high-valued patents. There are several computer-based techniques that can be used to calculate relative scores of patents within a patent landscape, so that patents can be compared with one another, but this still leaves the need for associating such relative scores with actual monetary estimates of value or worth. Part of the problem with this objective is that there is little calibration data intrinsically available within a typical patent landscape. Many patents have very little worth, and patents expire in a definite period of time, whereas some patents have a lot of worth and are extremely valuable because they can attract revenue through royalty streams and licensing, and because they are able to garnish significant judgments when infringement is proved, such as when a particular innovation serves as a seminal part of a valuable technology space. Innovation is what drives economies, governments, companies, and future wealth.

This disclosure teaches a computer-based technique for estimating a market value for individual patents within a patent landscape, by considering how markets value patent portfolios of innovative public companies (or other entities with a known market value). It is assumed that a relative seminality score is available for all patents within a patent landscape, which can be used to compare patents with each other. It is also assumed that patent ownership can be determined, in order to group patents into portfolios owned by entities with known market values, such as public companies traded on exchanges.

The present invention first assigns a proportion of the known market value of the portfolio owner to its portfolio, and then it imputes the value of the portfolio member patents to a wider grouping, such as classes and subclasses appropriate for the technology described by the patents. These wider groupings may include patents that do not belong to owners with known market values, and one can then impute the values for those patents using the seminality score of other patents belonging to portfolios that do have known market values. This boot-strapping technique can then be used to value every patent in the patent landscape. A feedback loop then uses these valuations to iteratively refine the proportions of the known market values that are attributed to each of the patent portfolios. Some portfolio owners might have significant market valuation and very few patents, whereas other portfolio owners might have low market valuation with a large number of patents that appear seminal within the patent landscape. This feedback loop is able to account for this discrepancy and work towards convergence so that in the end an accurate market calibration of the entire patent landscape is produced.

### BRIEF DESCRIPTION OF THE DRAWINGS

FIG. 1 presents a functional overview diagram of a known market value component as incorporated within a preferred embodiment.

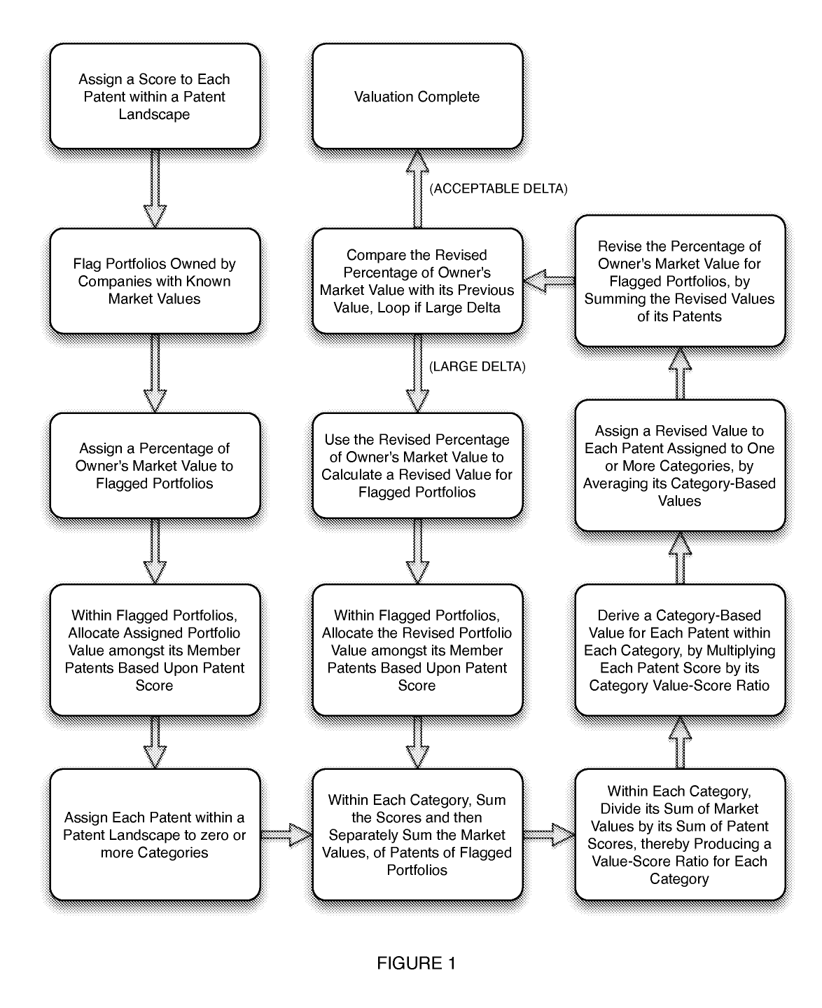

FIG. 2 presents a functional overview diagram of a known revenue stream component as incorporated within a preferred embodiment.

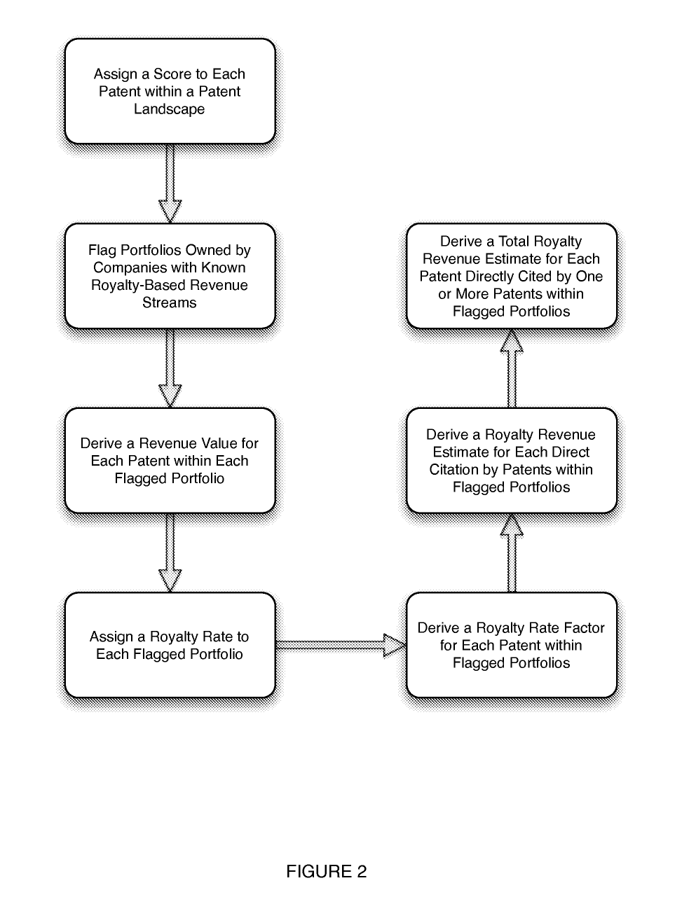

### DETAILED DESCRIPTION OF THE INVENTION

This disclosure teaches a computer-based technique for estimating a market value for individual patents within a patent landscape. A patent landscape, for example the set of all USPTO patents issued since 1970, can comprise millions of patents. The present invention comprises the use of a computer system with data storage sufficient to hold data representing an entire patent landscape, and a CPU or other device capable of processing said amount of data, either programmed, or in some other way configured, so as to implement one or more of the steps of the invention.

The present invention accepts as input the known market values of patent owners, the owned patents comprising a subset of a given patent landscape, and then utilizes known groupings of said patents to impute market value estimates for the rest of the patents in a given patent landscape. The method begins by assuming that a proportion of the owner's market value can be attributed to the patents that it owns, and then refines said proportions in an iterative fashion, ultimately refining the estimated market values of all patents within a patent landscape.

The initial steps of the method are directed towards input data. The first step assigns a metric score, S, to each patent within a patent landscape. This score, S, represents a weight in arbitrary units that is relative to every other patent in a patent landscape. There are multiple options for calculating said metric scores, S. The present invention does not attempt to define or promote any particular option. Said scores, S, must be assigned in such a fashion so that any two patents within a patent landscape can be compared relatively with each other.

Next, patents belonging to portfolios of publicly held companies, or companies, assignees, or owners having a known market capitalization value, M, are identified. An alternative to using market capitalization for market value M is to use Enterprise Value, which is market capitalization plus cash minus debt. The third initial step is to assign a proportion P to each of the said portfolios of publicly held companies, or companies, owners, or assignees having a known market value, M, representing the percentage value of the patent portfolio relative to M.

Once the initial data is gathered, the next step is to calculate a portfolio value, W, for each of the portfolios for which a value P has been assigned, by multiplying each said portfolio's proportion, P, by the market capitalization of its owner, M

W=P*M. (1)

Next, a portfolio value factor, T, is calculated for the portfolios with known market value, by dividing the portfolio value W by the sum of all the patent scores S of its member patents T

T=W/ΣS. (2)

Next, an estimate of the contributing market value, V, is calculated for each patent within each of the said portfolios with known market value, by multiplying the value factor, T, by the score, S

V=T*S. (3)

To produce market value estimates for all patents in the patent landscape, including those not belonging to publicly traded companies, or companies, owners, or assignees having a known market value, each patent within the patent landscape is assigned to zero or more categories, based upon the likelihood that said patents, with similar scores S, share similar estimated market values. In a preferred embodiment, said categories are comprised of the set of classes and subclasses defined by the issuing patent technology office or regulator. For each category, the sum of the market value estimates, V, of those patents belonging to a portfolio with known market value, and the metric scores, S, of each of said those patents can be summed. This produces a ratio value factor, R, calculated for each of the said categories by dividing each corresponding sum of market value estimates, V, by each corresponding sum of scores S

R=ΣV/ΣS. (4)

Each ratio value factor, R, is then used to calculate a category-specific market value estimate, VC, for each and every patent assigned to a category, by multiplying each score S of the patent by each said ratio value factor R of the category

VC=R*S. (5)

Next, a revised market value estimate, VR, is calculated for each and every patent by averaging the category-specific market value estimates, VC, from all categories to which a patent belongs

VR=Average(VC, taken over all categories to which each individual patent belongs). (6)

For those patents that belong to zero categories, the entire patent landscape is used as a category and the above steps are applied to calculate R, VC, and VR.

While the above steps describe a complete method for estimating the market value for any patent within a patent landscape, it is usually the case that many patents have very little worth, whereas some patents have a lot of worth and are extremely valuable because they can attract revenue through royalty streams and licensing, and because they are able to garnish significant judgments when infringement is proved. Further, because patents expire within a definite period of time, portfolios can be primarily comprised of patents at different points within their lifecycle.

At one extreme, some companies have many patent assets and derive much of their market value from the worth of those patents, while at the other extreme, some companies have very little assigned patents and derive their market value from other sources of revenue. Hence, a feedback loop can be incorporated to improve valuation accuracy, using patent market value estimates to iteratively refine the proportions of the known market values that are attributed to each of the company patent portfolios. This iterative feedback loop works as follows: We sum the market value estimates, VR, for each patent that is owned by companies used in the process with known market value, M, as described above. This sum of market value estimates is then used to derive a new company-specific proportion by dividing the sum of VR values by M

P=ΣVR/M, (7)

and this said new company-specific proportion, P, is then used with the steps described above to recalculate the market value estimate for every patent in the patent landscape. This process repeats until the difference between the new market value estimate and the old estimate is as small as desired.

In order to police the valuation figures produced by the preceding steps, the following independent set of valuation steps are performed, producing a second set of valuation numbers. Said steps produce both a distributed revenue estimate and a royalty revenue estimate, for each patent in a patent landscape.

The estimation of distributed revenue provides a way to apportion revenue values amongst patents that are cited by patents belonging to companies with known revenue streams, and the royalty revenue estimate is a quantity that describes the potential amount of revenue a patent may generate which it is needed to support patents with distributed revenue.

First, a relative weighting score, S, is assigned to each patent in a patent landscape. Next, patents belonging to portfolios of companies with a known revenue stream, A, are identified, and the sum of the patent relative weighting scores within each portfolio is calculated, producing a portfolio score PS

PS=ΣS. (8)

Next, a distributed revenue value, DRV, is derived for each patent belonging to portfolios of companies with a known revenue stream, A, by multiplying each patent score, S, by its portfolio revenue stream A, and dividing by the portfolio score, PS

DRV=S*A/PS. (9)

Note that only patents belonging to public companies with known revenue streams can obtain a non-zero distributed revenue value, DRV.

Next, each company with a known revenue stream, A, is assigned a royalty revenue rate, Y, which will subsequently be used to associate a royalty revenue, RR, to all patents cited by one or more patents with a non-zero distributed revenue value, DRV, as follows: the relative scores, S, of all patents cited by one or more patents with a non-zero distributed revenue value, DRV, are summed, and a royalty revenue factor, RRF, is derived by multiplying the royalty revenue rate, Y, by the distributed revenue value, DRV, and then dividing by the sum of the scores, S

RRF=Y*DRV/ΣS, (10)

where the sum is over all patents directly cited by the patent with non-zero distributed revenue, DRV.

Next, the associated royalty revenue estimate, RR, is produced by multiplying the royalty revenue factor, RRF, by the individual patent score, S, of the cited patent

RR=RRF*S. (11)

This process is repeated for each and every patent with a non-zero distributed revenue value estimate, DRV, so that all patents cited by such patents are allocated non-zero royalty revenue estimates, RR. Patents cited by more than one patent having a non-zero distributed revenue, DRV, receive RR allocations from each citation. These RR allocations are then summed to produce a total revenue estimate, TRR, for each cited patent

TRR=ΣRR. (12)

We claim:

1. A method of estimating the market value of individual patents within a patent landscape, comprising the steps of:
assigning a score S to each patent within a patent landscape, representing in arbitrary units its weight relative to its patent landscape;
identifying those patents belonging to portfolios owned by entities with a market value;
assigning an initial arbitrary value P to each of the said portfolios owned by entities with a market value, representing the percentage value of the portfolio relative to, the market value M of its owner;
calculating a value W for each of the said portfolios owned by entities with a market value, by multiplying each said portfolio's value P by the market, value M of its owner;
calculating a value factor T for each of the said portfolios owned by entities with a market value, by dividing each said portfolio's market value W by the sum of the patent scores S of its member patents; and
calculating a market value V for each patent within each portfolio, by multiplying each said patent's score S by its associated said portfolio value factor T.

2. The method of claim 1, further comprising the steps of:
assigning each patent within said patent landscape to zero or more categories based upon the likelihood that said patents with similar scores S share similar market values V;
summing within each category the market values V of those patents for which a market value has been calculated;
summing within each category the scores S of those patents for which a market value has been calculated;
calculating a ratio value R for each said category, by dividing each category's said sum of market values V by each category's said sum of scores S;
calculating a set of category-specific market values VC for each and every patent assigned to one or more categories, by multiplying each said patent's score S by each said category's ratio value R, and adding each result to each said patent's set of category-specific market values VC; and
calculating a revised market value VR for each and every patent assigned to one or more categories, by averaging the member values contained within each set of category-specific market values VC.

3. The method of claim 2, further comprising the steps of:
calculating a revised value P for each of the said portfolios owned by entities with a market value, by summing the revised market values VR of each patent within each said portfolio, and dividing said sum by the market value M of its owner;
repeating each of the previous ten steps one or more times, until the sum of all said revised market values VR converge, respectively, within an arbitrary value D, with the previous sum of all said revised market values VR.

4. The method of claim 3, wherein the step of calculating a ratio value R for each said category further comprises the steps of:
averaging the ratio Rs of those categories for which a ratio R has been calculated; and
assigning said average ratio value R to those categories for which a ratio R has not been calculated.

5. The method of claim 3, wherein the step of calculating a ratio value R for each said category further comprises the steps of:
grouping categories into super-categories based upon the likelihood that said groupings contain categories whose patents with similar scores S share similar market values V;
averaging within each super-category the ratio Rs of its member categories for which a ratio R has been calculated; and
assigning said super-category average ratio values R to member categories for which a ratio R has not been calculated.

6. The method of one of claims 2-5, wherein said patent categories, are comprised of the set of USPTO classes.

7. The method of one of claims 2-5, wherein said patent categories are comprised of the set of USPTO classes and subclasses.

8. The method of one of claims 1-5 wherein said entities with a market value are comprised, of the set of publicly held companies.

9. A method of estimating the market value of individual patents within a patent landscape, comprising the steps of:
assigning a score S to each patent within a patent landscape, representing in arbitrary units its weight relative to its patent landscape;
identifying those patents within said patent landscape with a known market estimate, and assigning, said market estimate to said those patents;
assigning each patent within said patent landscape to zero or more categories based upon the likelihood that said patents with similar scores S share similar market values V;
summing within each category the market values V of those patents for which a market value has been assigned;
summing, within each category the scores S of those patents for which a market value has been calculated;
calculating a ratio value R for each said category, by dividing each category's said sum of market values V by each category's said sum of scores S;
calculating a set of category-specific market values VC for each and every patent assigned to one or more categories, by multiplying each said patent's score S by each said category's ratio value R, and adding each result to each said patent's set of category-specific market values VC; and,
calculating a revised market value VR for each and every patent assigned to one or more categories, by averaging the member values contained within each set of category-specific market values VC.

10. A method of estimating the market value of individual patents within a patent landscape, comprising the steps of:
assigning, a score S to each patent in a patent landscape, representing in arbitrary units its weight relative to its patent landscape;
identifying those patents belonging to a portfolio within said patent landscape for which a portfolio revenue value A has been ascertained, and assigning said revenue values A to said portfolios;
summing the patent scores S within one or more portfolios, producing a portfolio score PS for each portfolio;
calculating a revenue value DRV for each patent belonging to portfolios which have been assigned revenue values A, by multiplying each, said patent's score S by its portfolio revenue value A, and dividing by its portfolio score PS;
assigning a royalty rate Y to each portfolio which has been assigned a revenue value A;
calculating a royalty revenue factor RRF for each patent belonging to a portfolio which has been, assigned a royalty rate Y, by multiplying, each said patent's revenue value DRV by its portfolio royalty rate Y, and dividing by the sum of the scores S of the patents directly cited by each said patent;
calculating an associated royalty revenue estimate RR for each direct citation from patents belonging to a portfolio which has been assigned a royalty rate Y, by multiplying the cited patent's score S by the citing patent's royalty revenue factor RRF; and
summing the individual royalty revenue estimates RR associated with the direct citations to a given patent, producing a total royalty revenue estimate TRR for each said patent.
